(19) United States
(12) Patent Application Publication
(10) Pub. No.: US 2025/0196509 A1
(43) Pub. Date: Jun. 19, 2025

(54) PRINTING APPARATUS AND CONTROL METHOD

(71) Applicant: CANON KABUSHIKI KAISHA, Tokyo (JP)

(72) Inventors: YASUNORI FUJIMOTO, Tokyo (JP); NATSUKO HATTORI, Kanagawa (JP); JUN YASUTANI, Kanagawa (JP)

(21) Appl. No.: 18/977,574

(22) Filed: Dec. 11, 2024

(30) Foreign Application Priority Data
Dec. 15, 2023 (JP) 2023-212321

(51) Int. Cl. B41J 2/21; H04N 1/00

(52) U.S. Cl. CPC B41J 2/2146; B41J 2/2103; B41J 2/2114; B41J 2/2135; H04N 1/00039; H04N 1/00045; H04N 1/00087; H04N 2201/0094

(57) ABSTRACT

A printing apparatus includes printheads arranged in a first direction, a moving unit relatively moving the printheads and a print medium in the first direction, a reading unit reading a test pattern on a print medium, an analyzing unit analyzing the test pattern, and a correcting unit correcting displacements of printing positions of the printheads based on an analysis result. Each printhead includes chips arranged in a longitudinal direction of the printhead. Each chip includes nozzles arranged in the longitudinal direction. The test pattern includes determination patterns arranged in a second direction intersecting the first direction. Each determination pattern includes a pattern printed by each printhead. The analyzing unit analyzes a position displacement between a reference direction and the longitudinal direction of each printhead. The reference direction is determined from longitudinal directions of at least two printheads.

### BACKGROUND

### Field of the Disclosure

The present disclosure relates to a printing apparatus and a control method.

### Description of the Related Art

There is known a long printhead having a long printing width with a plurality of head chips (head substrates) joined in the nozzle array direction. A printhead called a full-line head is an example of such a printhead. The installation error of such a printhead has an influence on a printing position displacement (for example, the landing position displacement of ink). This displacement causes a deterioration in print quality. Japanese Patent Laid-Open Nos. 2012-035477, 2020-172084, and 2020-023111 disclose techniques of correcting a printing position displacement due to an installation error based on the read result of a printed test pattern.

The inclination of a long printhead having a plurality of head chips joined in the nozzle array direction with respect to the main scanning direction has a high influence on a printing position displacement. The related art has room for improvement in specifying the inclination of the printhead.

### SUMMARY

Embodiments of the present disclosure provide a technique that can reduce a printing position displacement due to the inclination of a printhead.

According to embodiments of the present disclosure, there is provided a printing apparatus comprising: a plurality of printheads arranged in a first direction; a moving unit configured to relatively move the plurality of printheads and a print medium in the first direction; a reading unit configured to read a test pattern on a print medium printed by the plurality of printheads; an analyzing unit configured to analyze the test pattern read by the reading unit; and a correcting unit configured to correct displacements of printing positions of the plurality of printheads based on an analysis result obtained by the analyzing unit, wherein each printhead includes a plurality of chips arranged in a longitudinal direction of the printhead which intersects the first direction, each chip including a plurality of nozzles arranged in the longitudinal direction, the test pattern includes a plurality of determination patterns arranged in a second direction intersecting the first direction, each determination pattern includes a pattern printed by each printhead, the analyzing unit analyzes a position displacement between a reference direction and the longitudinal direction of each printhead specified from the plurality of determination patterns, the reference direction is determined from longitudinal directions of at least two printheads specified from the plurality of determination patterns, and the correcting unit corrects a displacement of a printing position based on the position displacement analyzed by the analyzing unit.

Further features of the present disclosure will become apparent from the following description of exemplary embodiments (with reference to the attached drawings).

### BRIEF DESCRIPTION OF THE DRAWINGS

FIG. 1 is a view for explaining the internal structure of a printing apparatus according to an embodiment of the present disclosure.

FIGS. 2A and 2B are views for explaining the operation of the printing apparatus in FIG. 1.

FIG. 3 is a functional block diagram showing an example of a function implemented by a control unit.

FIG. 4 is a view for explaining a printhead.

FIG. 5 is a view for explaining a test pattern.

FIGS. 6A and 6B are views for explaining a determination pattern.

FIG. 7 is a view for explaining a tile pattern.

FIG. 8 is a view for explaining a method of analyzing an error in a constituent element of the printhead.

FIGS. 9A to 9C are views for explaining an issue concerning the analysis of an error between a plurality of printheads.

FIGS. 10A and 10B are views for explaining a determination pattern.

FIGS. 11A to 11C are views for explaining a method of determining a reference direction.

FIGS. 12A to 12D are views for explaining a method of calculating the position displacement of the printhead in the X direction.

FIG. 13 is a view for explaining a method of calculating the position displacement of the printhead in the Y direction.

FIG. 14 is a view for explaining a method of shifting print data.

FIG. 15 is a view for explaining a method of shifting print data.

FIG. 16 is a view for explaining a method of shifting print data.

FIGS. 17A to 17D are views for explaining a method of calculating the position displacement of the printhead in the X direction.

FIG. 18 is a view for explaining a method of calculating a displacement (in the X direction) between chips.

FIG. 19 is a flowchart showing an example of reference direction selection processing.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

An embodiment of the present disclosure will be described in detail below with reference to the accompanying drawings. The following will exemplify a printing apparatus using an inkjet printing scheme. A printing apparatus may, for example, be a single function printer having only a printing function or a multifunction printer having a plurality of functions such as a printing function, a FAX function, and a scanner function. Alternatively, a printing apparatus may be a manufacturing apparatus for manufacturing, for example, color filters, electronic devices, optical devices, and microstructures by a predetermined printing scheme.

Note that “printing” not only includes the formation of significant information such as characters and graphics but also broadly includes the formation of images, figures, patterns, and the like on a print medium, or the processing of the medium, regardless of whether they are significant or insignificant and whether they are so visualized as to be visually perceivable by humans. In addition, this embodiment assumes a sheet of paper as “print medium” but may use cloth, a plastic film, and the like. “Ink” includes a liquid which, when applied onto a print medium, forms images, figures, patterns, and the like, processes the print medium, or processes ink (for example, solidify or insolubilize a coloring material contained in ink applied to the print medium).

### First Embodiment

### Outline of Printing Apparatus

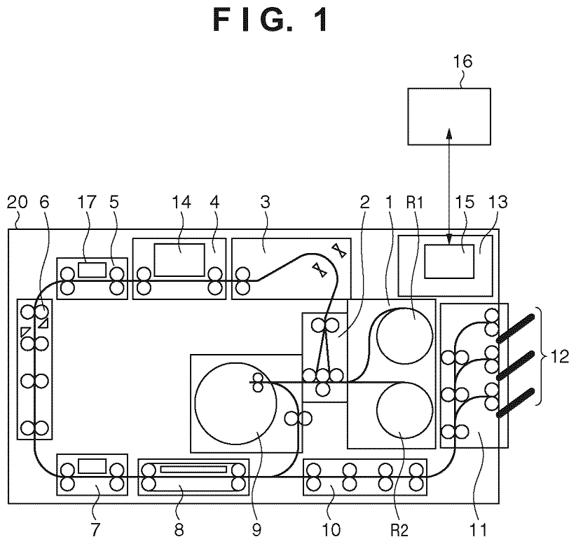

FIG. 1 is a view showing an example of the internal arrangement of a printing apparatus 20 according to an embodiment of the present disclosure. The printing apparatus 20 is a high-speed line printer that uses a continuous sheet wound in a roll and is compatible with single-sided printing and double-sided printing. The printing apparatus 20 described above is suitable for, for example, the field of large-volume printing in a print shop and the like.

The printing apparatus 20 is internally provided with a sheet supply unit 1, a de-curl unit 2, a skew correcting unit 3, a printing unit 4, a checking unit 5, a cutter unit 6, an information printing unit 7, a drying unit 8, a sheet take-up unit 9, and a discharging/conveying unit 10. In addition, the printing apparatus 20 is internally provided with a sorter unit 11, a discharging tray 12, and a control unit 13.

A sheet S, which is a print medium, is conveyed by a conveying mechanism including roller pairs and a belt along a sheet conveyance path indicated by the solid lines in FIG. 1. The units provided on this conveyance path in the printing apparatus 20 perform various types of processing on the sheet S.

The sheet supply unit 1 accommodates and supplies a continuous sheet wound in a roll. The sheet supply unit 1 is configured to accommodate two rolls R1 and R2 and selectively take out and supply the sheet S. Note that the number of rolls that can be accommodated need not be two, and the sheet supply unit 1 may be configured to accommodate one roll or three or more rolls.

The de-curl unit 2 reduces the curl (warpage) of the sheet S supplied from the sheet supply unit 1. The de-curl unit 2 curves the sheet S so as to give reversed warpage to the sheet S by using two pinch rollers with respect to one drive roller. This reduces the curl of the sheet S.

The skew correcting unit 3 corrects the skew of the sheet S (the inclination relative to the original traveling direction) passing through the de-curl unit 2. The skew correcting unit 3 corrects the skew of the sheet S by pressing a sheet end portion on the reference side against a guide member.

The printing unit 4 forms and prints an image on a conveyed sheet. The printing unit 4 is provided with a plurality of inkjet printheads (to be simply referred to as printheads hereinafter) 14 in addition to a plurality of conveying rollers that convey a sheet. Each printhead 14 is implemented by a full-line type printhead and has a printing width corresponding to the maximum width of the sheet S assumed to be used.

The plurality of printheads 14 are arranged parallel along the conveying direction of the sheet S. This embodiment is provided with the four printheads 14 respectively corresponding to four colors, namely black (K), cyan (C), magenta (M), and yellow (Y). The printheads 14 are arranged in the order of, for example, K, C, M, and Y from the downstream side in the conveying direction of the sheet S. The respective printheads 14 are arranged such that the printing widths are aligned with the conveying direction of the sheet S.

Note that the number of colors and the number of printheads need not necessarily be four and can be changed as needed. Examples of the inkjet scheme include a scheme using heating elements, a scheme using piezoelectric elements, a scheme using electrostatic elements, and a scheme using MEMS elements. Inks of the respective colors are respectively supplied from ink tanks to the printheads 14 through ink tubes.

The checking unit 5 is provided with a reading unit 17. In this embodiment, the reading unit 17 is a CCD line sensor. The CCD line sensor is implemented by, for example, a two-dimensional image sensor and has a plurality of reading elements arranged in a direction intersecting the conveying direction of the sheet S. In addition, the checking unit 5 is also provided with a light-emitting element. With this arrangement, the checking unit 5 optically reads a pattern or image printed on a sheet by the printing unit 4 and checks the states of nozzles of the printhead 14, the conveyance state of a sheet, the position of an image, and the like.

The cutter unit 6 is a mechanism that cuts a sheet after image printing to a predetermined length. The cutter unit 6 is provided with a plurality of conveying rollers for feeding out the sheet to the next step. The information printing unit 7 prints information such as a serial number and a date on the reverse surface of the cut sheet. The drying unit 8 dries the applied ink (in a short time) by heating the sheet on which the image is printed by the printing unit 4. The drying unit 8 is provided with a conveyance belt and conveying rollers for feeding out the sheet to the next step.

The sheet take-up unit 9 temporarily takes up the sheet S having undergone printing on the obverse surface in double-sided printing. The sheet take-up unit 9 is provided with a take-up drum that rotates to take up the sheet S. Upon completion of printing on the obverse surface, the sheet S that is not cut by the cutter unit 6 is temporarily taken up by the take-up drum. Upon completion of taking up, the take-up drum reversely rotates to feed the taken-up sheet S to the printing unit 4 through the de-curl unit 2. Since the sheet S is reversed, the printing unit 4 can print on the reverse surface. A specific operation concerning double-sided printing will be described later.

After the sheet S is cut by the cutter unit 6, the discharging/conveying unit 10 conveys the sheet S dried by the drying unit 8 to the sorter unit 11. The sorter unit 11 discharges the sheet S on which an image is printed to the discharging tray 12. At this time, the sheets S may be sorted and discharged to the different discharging trays 12.

The control unit 13 is an electronic circuit that controls the respective units of the printing apparatus 20. The control unit 13 includes, for example, a controller 15 including a processor such as a CPU, a storage device such as a semiconductor memory, and various types of I/O interfaces, a power supply, a display device, and an input device. The operation of the printing apparatus 20 is controlled based on commands from the controller 15 or an external device 16 (a host computer or the like) connected to the controller 15 via an I/O interface.

### Operation Example

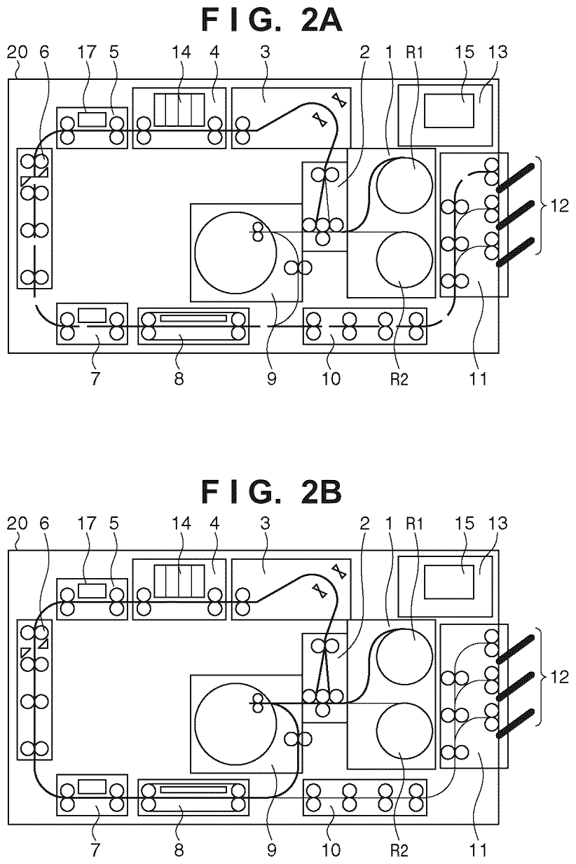

A basic operation procedure in printing processing will be described next with reference to FIGS. 2A and 2B. Printing processing differs between single-sided printing and double-sided printing, and hence each processing will be described below. In this case, FIG. 2A is a view for explaining an operation in single-sided printing. Referring to FIG. 2A, the thick line indicates the conveyance path through which the sheet S is discharged onto the discharging tray 12 after an image is printed on the sheet S supplied from the sheet supply unit 1.

When the sheet supply unit 1 supplies the sheet S, the de-curl unit 2 and the skew correcting unit 3 process the sheet S, and the printing unit 4 prints an image on the sheet S. The cutter unit 6 cuts the sheet S on which the image is printed to a predetermined length upon passing through the checking unit 5. The information printing unit 7 prints information such as the date on the reverse surface of the cut sheet S as needed. Subsequently, the drying unit 8 dries the sheet S one at a time. The sheet S is then discharged onto the discharging tray 12 of the sorter unit 11 through the discharging/conveying unit 10.

FIG. 2B is a view for explaining an operation in double-sided printing. In double-sided printing, after a printing sequence on the obverse surface of the sheet S, a printing sequence on the reverse surface of the sheet S is executed. Referring to FIG. 2B, the thick line indicates the conveyance path at the time of printing an image on the obverse surface of the sheet S in double-sided printing.

In this case, the operations of the respective units from the sheet supply unit 1 to the checking unit 5 are the same as those in the single-sided printing described with reference to FIG. 2A. The difference between these operations resides in processing after the cutter unit 6. More specifically, when the sheet S is conveyed to the cutter unit 6, the cutter unit 6 cuts the trailing end of the printing area of the continuous sheet S without cutting the sheet S for each predetermined length. When the sheet S is conveyed to the drying unit 8, the sheet S is conveyed to the sheet take-up unit 9 instead of the discharging/conveying unit 10 after the drying unit 8 dries the ink on the obverse surface of the sheet S.

The conveyed sheet S is taken up by the take-up drum of the sheet take-up unit 9 that rotates in the forward direction (the counterclockwise direction in the case shown in FIG. 2B). That is, the sheet S is completely taken up by the take-up drum up to the trailing end (cut position). Note that the continuous sheet S on the upstream side in the conveying direction with respect to the cut position of the sheet S cut by the cutter unit 6 is wound back to the sheet supply unit 1 such that the leading end (cut position) of the sheet S is not left at the de-curl unit 2.

When the printing sequence for the obverse surface of the sheet S is finished, a printing sequence for the reverse surface of the sheet S is started. When this sequence is started, the take-up drum rotates in the opposite direction to that at the time of taking up the sheet S (in the clockwise direction in FIG. 2B). An end portion of the taken-up sheet S (the trailing end of the sheet S at the time of taking up becomes the leading end of the sheet S at the time of feeding) is conveyed to the de-curl unit 2. The de-curl unit 2 corrects the curl of the sheet S in the opposite direction to that at the time of printing an image on the obverse surface. This is because the sheet S wound around the take-up drum is reversely wound with respect to the roll at the sheet supply unit 1 and is curled in the opposite direction.

Subsequently, the sheet S is conveyed to the printing unit 4 through the skew correcting unit 3, and an image is printed on the reverse surface of the sheet S. The sheet S on which the image is printed is cut to a predetermined length by the cutter unit 6 after undergoing the checking unit 5. The cut sheet S has images printed on both surfaces, and hence the information printing unit 7 does not print information such as the date. Subsequently, the sheet S is discharged onto the discharging tray 12 of the sorter unit 11 through the drying unit 8 and the discharging/conveying unit 10.

### Control Unit

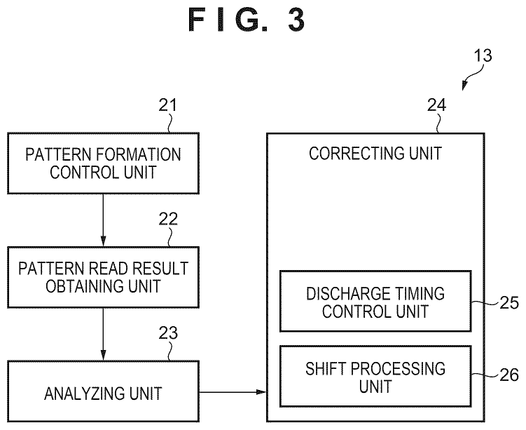

FIG. 3 is a functional block diagram showing an example of a function implemented by the control unit 13 shown in FIG. 1. Note that the function shown in FIG. 3 is implemented by, for example, the CPU reading out and executing programs stored in a memory or the like.

The control unit 13 includes a pattern formation control unit 21, a pattern read result obtaining unit 22, an analyzing unit 23, and a correcting unit 24 as functional components.

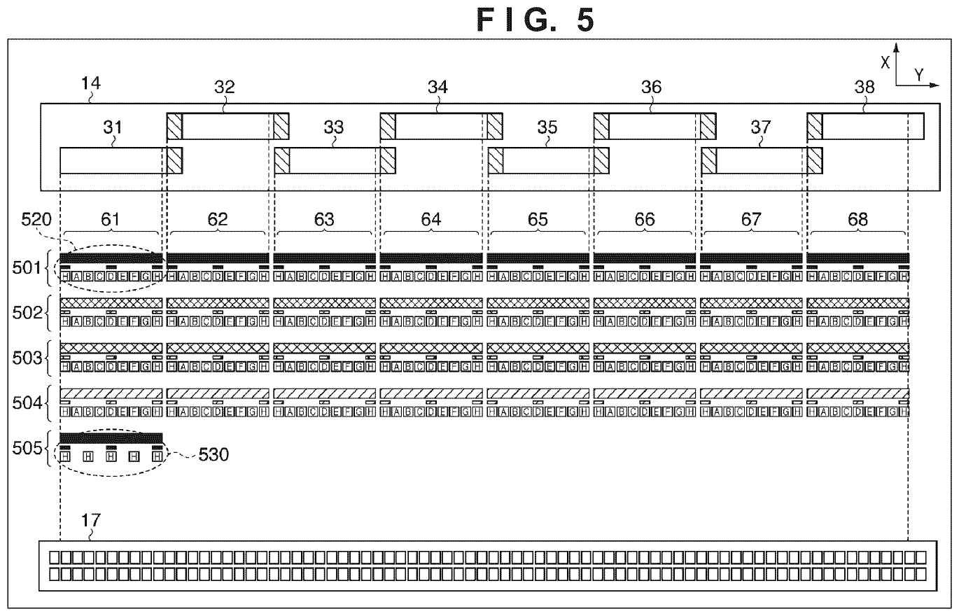

The pattern formation control unit 21 controls the printing of a test pattern (adjustment pattern) for measuring the displacement of the landing position (adhesion position) of ink discharged from each nozzle array of each printhead 14. The details of the test pattern will be described later with reference to FIG. 5.

The pattern read result obtaining unit 22 obtains a read result on the test pattern printed on the sheet S. In this embodiment, the reading unit 17 provided in the checking unit 5 reads the test pattern. The analyzing unit 23 calculates a displacement amount originating from a manufacturing error, installation error, or the like between the constituent elements of the printhead 14 and between the printheads 14 base on the read result of the test pattern. In other words, the analyzing unit 23 calculates the displacement amount of the actual landing position of ink with respect to the ideal landing position of ink.

The correcting unit 24 corrects the displacement of the landing position of ink discharged from a nozzle of each printhead 14 based on the displacement amount calculated by the analyzing unit 23. The correcting unit 24 is provided with a discharge timing control unit 25 that controls the discharge timing of ink from each nozzle and a shift processing unit 26 that shifts the area of a nozzle used for printing. The above description concerns an example of the function implemented by the control unit 13.

### Arrangement of Printhead

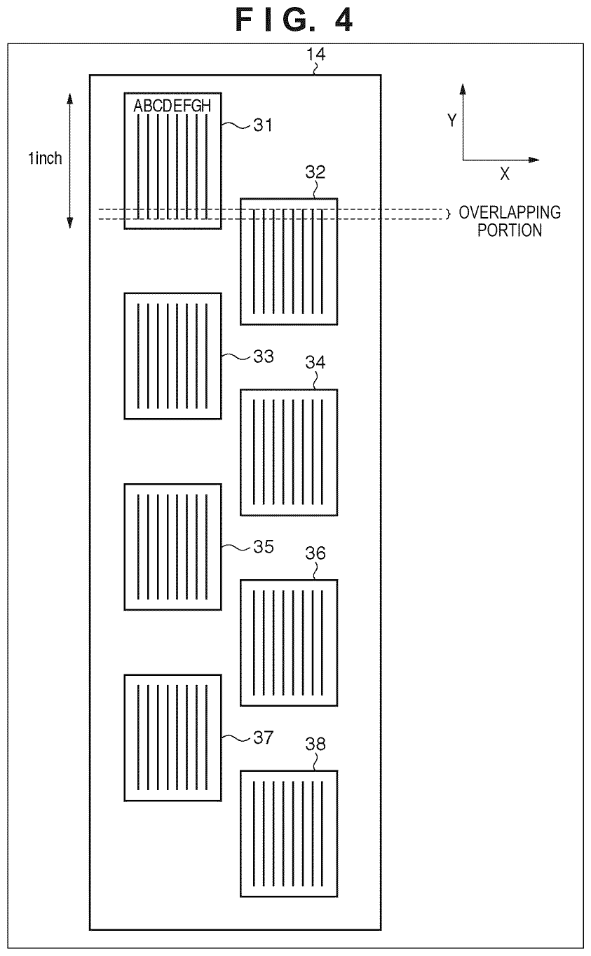

The arrangement of each printhead 14 according to this embodiment will be described next with reference to FIG. 4. Since the plurality of printheads 14 each have the same arrangement, one printhead will be exemplified. In each drawing, “X” and “Y” respectively indicate directions intersecting each other. In this embodiment, these directions are orthogonal to each other. The X direction is the conveying direction of the sheet S and the sub-scanning direction. The Y direction is the nozzle array direction and the main scanning direction.

This embodiment assumes the use of the four printheads 14, which respectively discharge different types of inks. In the embodiment, the different types of inks are assumed to be inks of four colors, namely black (K), cyan (C), magenta (M), and yellow (Y).

Each printhead 14 has, for example, eight chips 31 to 38, each formed from silicon and having an effective discharge width of about 1 inch, arranged on a base substrate (support member) in the Y direction. In this embodiment, the chips 31 to 38 are arranged in a staggered pattern. In other words, two chip arrays each having four chips arranged in the Y direction are arranged so as to be spaced apart from each other in the X direction with their positions being displaced in the Y direction.

A plurality of nozzle arrays are formed on each of the chips 31 to 38. More specifically, the eight nozzle arrays (nozzle arrays A to H) are arranged parallel to each other. Each nozzle array has a plurality of nozzles formed in the nozzle array direction (Y direction). In addition, the eight nozzle arrays are spaced apart from each other in the X direction.

Of the chips 31 to 38, each pair of chips adjacent to each other in the Y direction are configured to overlap by a predetermined number of nozzles. More specifically, some nozzles of the nozzle arrays of each pair of chips adjacent to each other are arranged to overlap in the Y direction (nozzle array direction). Note that each of the chips 31 to 38 is also provided with a temperature sensor (not shown) that measures the temperature of the chip. Each nozzle (orifice) is provided with, for example, a printing element (heater) implemented by a heating resistive element. The printing element energizes/heats a liquid to cause it to be foamed and discharges the liquid from the orifice using the generated kinetic energy.

Each printhead 14 is configured such that the effective discharge width is about 8 inches and almost coincides with the length of an A4 printing sheet. That is, it is possible to complete the printing of an image by 1-pass scanning.

### Test Pattern

FIG. 5 shows an example of a test pattern. FIG. 5 also shows the positional relationship between the test pattern, the printhead 14, and the reading unit 17. Note that the test pattern in FIG. 5 is printed with the ink discharged from the four printheads 14. FIG. 5 representatively shows one printhead 14. The reading unit 17 includes a plurality of reading elements 17a arranged such that the Y direction coincides with the element array direction. The reading width constituted by the plurality of reading elements 17a includes the printing width of the printhead 14.

The test pattern includes a plurality of determination patterns 61 to 68. The determination patterns 61 to 68 are head individual analysis patterns for analyzing the errors of the constituent elements of the printhead 14. Each determination pattern is printed by a chip coinciding in the last digit of the reference numeral. For example, the determination pattern 61 is printed by using the nozzles of the chip 31. The determination pattern 68 is printed by using the nozzles of the chip 38.

Determination patterns 501 to 504 are printed by the different printheads 14. Likewise, the determination pattern 501 is printed by the black (K) printhead 14. The determination pattern 502 is printed by the cyan (C) printhead 14. The determination pattern 503 is printed by the magenta (M) printhead 14. The determination pattern 504 is printed by the yellow (Y) printhead 14.

In summary, for example, the determination pattern 501/61 is a pattern printed by using the nozzles of the chip 31 of the black (K) printhead 14. The determination pattern 502/62 is a pattern printed by using the nozzles of the chip 32 of the cyan (C) printhead 14. The determination pattern 503/66 is a pattern printed by using the nozzles of the chip 36 of the magenta (M) printhead 14. The determination pattern 504/68 is a pattern printed by using the nozzles of the chip 38 of the yellow (Y) printhead 14. The displacements (in the X direction) between nozzle arrays, the displacements (in the X and Y directions) between chips, and the inclinations of chips are measured for each printhead 14 from read results on the determination patterns 61 to 68.

The test pattern also includes a plurality of determination patterns 505 arranged in the Y direction. The determination patterns 505 are inter-head analysis patterns for analyzing the errors between the printheads 14. In this embodiment, the two determination patterns 505 are provided so as to be spaced apart in the Y direction. One of the patterns is printed by using the nozzles of the chip 31 of each printhead 14. The other of the patterns is printed by using the nozzles of the chip 38 of each printhead 14.

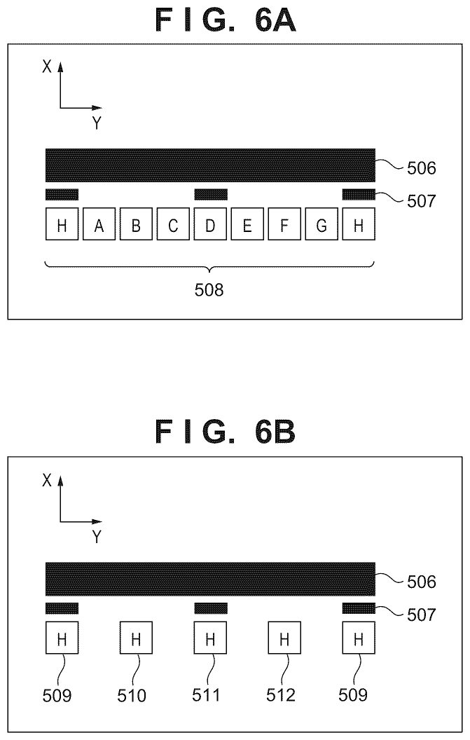

FIG. 6A is an enlarged view of the determination pattern 61 in a dotted line frame 520 indicated in FIG. 5. The determination patterns 62 to 68 each also have the same arrangement.

A detection bar 506 is used to detect the specific color of a read pattern in analyzing the image read by the reading unit 17. For example, if the R channel value of an RGB image forming the detection bar 506 is 10 or less, the CPU detects that the pattern is a K pattern. If the R channel value is 10 or more and 60 or less, the CPU detects that the pattern is a C pattern. If the G channel value is 10 or more and 60 or less, the CPU detects that the pattern is an M pattern. If the B channel value is 10 or more and 60 or less, the CPU detects that the pattern is a Y pattern.

The determination pattern 61 also includes a reference mark 507 and a tile pattern 508 used for pattern matching. The tile pattern 508 is detected with reference to the reference mark 507 and formed at a position spaced a predetermined number of pixels apart from the reference mark 507. All the tile patterns 508 are formed of identical patterns and printed by different nozzle arrays on the same chip. More specifically, the tile pattern 508 is printed by using a predetermined number of some consecutive nozzles of each nozzle array arranged on the same chip. Note that the predetermined number of some consecutive nozzles do not overlap each other in the nozzle array direction in each nozzle array. In printing the tile pattern 508, there is no need to use all the nozzle arrays arranged on the same chip, and the tile pattern 508 may be printed by using at least one nozzle array.

The letters added to the tile pattern 508 indicate nozzle arrays used for printing. For example, “H” indicates the tile pattern printed by using nozzle array H shown in FIG. 4. Likewise, “A” indicates the tile pattern printed by using nozzle array A. The tile pattern 508 includes the tile patterns printed by all nozzle arrays A to H and also includes two tile patterns associated with nozzle array H. The two tile patterns printed by nozzle array H are located at two end portions in the Y direction.

FIG. 6B is an enlarged view of the determination pattern 505 indicated by a dotted line frame 530 shown in FIG. 5. Like the determination pattern 61 shown in FIG. 6A, the determination pattern 505 includes a detection bar 506 and a reference mark 507. The determination pattern 505 also includes tile patterns 509 to 512 used for pattern matching.

The tile pattern 509 is printed by using the black (K) printhead 14. The tile pattern 510 is printed by using the cyan (C) printhead 14. The tile pattern 511 is printed by using the magenta (M) printhead 14. The tile pattern 512 is printed by using the yellow (Y) printhead 14.

Of the two determination patterns 505, one pattern is printed by using the nozzles of the chip 31 of each printhead 14, and the other pattern is printed by using the nozzles of the chip 38 of each printhead 14. That is, of the chips 31 to 38, the chips 31 and 38 located at two end portions in the Y direction are used. All the tile patterns 509 to 512 are formed of identical patterns and printed by using the nozzles of the same nozzle array (nozzle array H in this embodiment). That is, the tile patterns 509 to 512 are printed by using the nozzle arrays arranged at predetermined positions in the chips arranged at corresponding positions in the respective printheads.

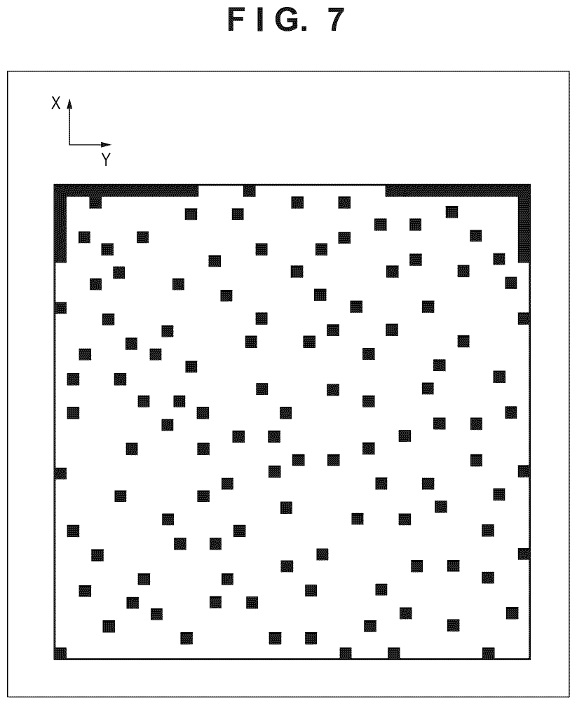

The tile patterns 508 to 512 each are a rectangular pattern and, for example, printed by a random dot pattern as shown in FIG. 7.

As shown in FIG. 5, all the tile patterns 508 are arranged in a direction (Y direction) parallel to the element array direction of the reading elements 17a of the reading unit 17. In other words, these patterns are printed so as to be arranged side by side in the Y direction. Likewise, as shown in FIG. 5, the tile patterns 509 to 512 are arranged in a direction (Y direction) parallel to the element array direction of the reading elements 17a of the reading unit 17. In other words, these patterns are printed so as to be arranged side by side in the Y direction.

The tile patterns 508 to 512 are arranged in a direction (Y direction) parallel to the array of the reading elements 17a of the reading unit 17 of the checking unit 5. For this reason, even if read images change in size due to a conveyance error, since all the tile patterns in the read images change in size similarly, relative size changes between the tile patterns are small. This makes it possible to accurately measure the distances between the tile patterns.

### Errors of Constituent Elements of Printhead

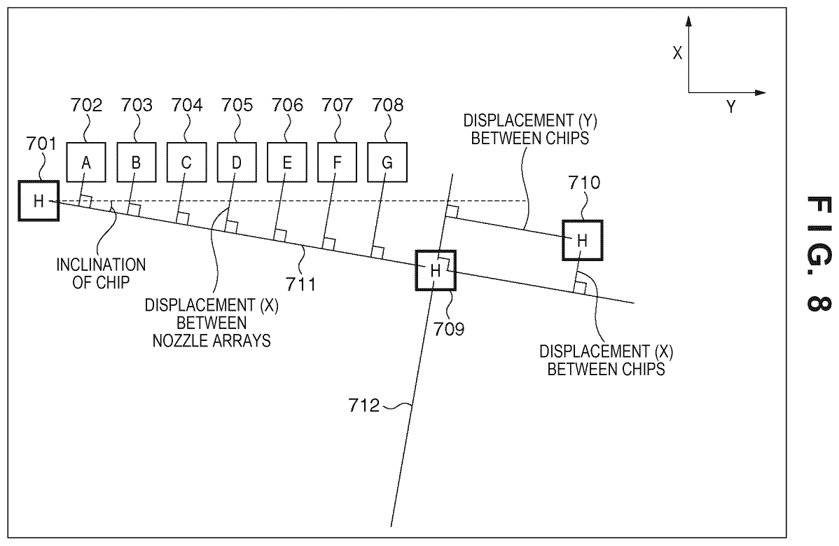

A method of analyzing the displacement amounts of the constituent elements of the printhead 14 as the errors of the constituent elements will be described next with reference to FIG. 8. These displacement amounts are obtained based on the relative positional relationship between the tile patterns 508 of the determination patterns 61 to 68. The displacement amounts calculated in this embodiment include (1) the displacements (in the X direction) between nozzle arrays, (2) the inclinations of chips, (3) the displacements (in the X direction) between chips, and (4) the displacements (in the Y direction) between chips.

All the tile patterns 508 are printed by identical patterns. For this reason, pattern matching is performed between the tile patterns in the tile pattern 508 to calculate the distance (the number of pixels) between patterns, of the tile patterns, which have the highest correlation. Each type of displacement amount is calculated from the difference between the number of pixels between the tile patterns at an ideal position and the calculated number of pixels between the tile patterns. Note that a general method may be used as a pattern matching method.

The displacements (in the X direction) between the nozzle arrays are obtained by calculating the displacement amounts of the tile patterns printed by the nozzle arrays other than nozzle array H with respect to the tile patterns printed by nozzle arrays H. Tile patterns 701 to 709 in FIG. 8 correspond to the tile pattern 508 printed by using the nozzles on the same chip. A tile pattern 710 indicates a tile pattern printed by using the nozzles of adjacent another chip.

In calculating the inter-nozzle displacement amount (in the X direction) of nozzle array A relative to nozzle array H, a perpendicular line is dropped from the tile pattern 702 printed by nozzle array A to a straight line 711 connecting the tile patterns 701 and 709 printed by nozzle array H. The distance of the vertical line is then calculated to calculate the difference from the distance at an ideal position. This will calculate the inter-nozzle displacement amount (in the X direction) of nozzle array A relative to nozzle array H. It is possible to calculate the inter-nozzle displacement amounts of nozzle arrays B to G relative to nozzle array H in the same manner. Using the line 711 connecting the tile patterns 701 and 709 printed by nozzle array H as a reference makes it possible to remove the influence of skew at the time of reading printed patterns.

The inclination of a chip is obtained by calculating the inclination of the straight line 711 with respect to the element array direction (broken line) of the reading unit 17. That is, the inclination of a chip is obtained by calculating the inclination of the straight line 711 with respect to an axis of the two-dimensional coordinate system of a read image.

The displacement (in the X direction) between chips is obtained by dropping a vertical line from a tile pattern 710 printed by using the nozzles of an adjacent chip to the straight line 711, calculating the distance of the vertical line, and calculating the difference from the distance at an ideal position. This makes it possible to calculate the displacement amount between the adjacent chips in the X direction.

The displacement (in the Y direction) between the chips is obtained by drawing a straight line 712 orthogonal to the line 711 on the tile pattern 709, dropping a vertical line from the tile pattern 710 to the straight line 712, calculating the distance of the vertical line, and calculating the difference from the distance at an ideal position. This makes it possible to calculate the displacement amount between the adjacent chips in the Y direction.

### Errors Between Printheads

The analysis of errors occurring between the plurality of printheads 14 will be described. The following will exemplify position displacements caused by the inclinations of the printheads 14 in the longitudinal direction. The longitudinal direction of the printhead 14 is reworded as the nozzle array direction and the chip array direction.

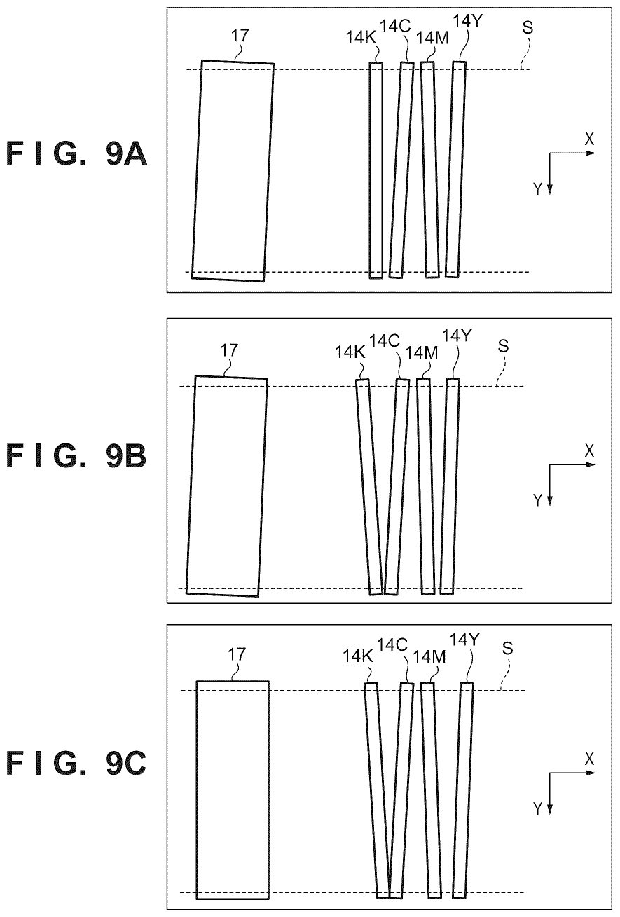

In analyzing such errors, with reference to the specific printhead 14 (for example, the black ink printhead), the displacement amounts of the positions of the other printheads 14 may be calculated. In this method, however, the error of the printhead itself serving as a reference can have an influence. Although it is possible to improve the mounting accuracy of the printhead as a reference, this becomes a cost factor. This point will be described with reference to FIGS. 9A to 9C.

FIGS. 9A to 9C shows a black (K) printhead 14K, a cyan (C) printhead 14C, a magenta (M) printhead 14M, a yellow (Y) printhead 14Y, and the reading unit 17.

FIG. 9A shows a case where it may be determined that the printhead 14K is most vertical to the conveying direction of the sheet S. That is, the longitudinal direction of the printhead 14K almost coincides with the Y direction. In this case, the displacement of the printing position due to the inclination of each of the printheads 14C to 14Y may be corrected by using the printhead 14K as a reference.

In contrast to the above case, as shown in FIGS. 9B and 9C, the printhead 14K may not be most vertical to the conveying direction of the sheet S. In this case as well, if the printhead 14K is set as a reference, although the printing position displacements between the different colors can be reduced, the overall printed image inclines relative to the sheet S. The quality of the output product sometimes deteriorates.

Accordingly, in this embodiment, the errors between the printheads 14 are analyzed by using the determination patterns 505 at two positions without setting the specific printhead 14 as a reference. More specifically, the displacement amounts in the X direction between the printheads 14 due to the inclinations of the printheads 14 are calculated based on the relative positional relationship between the determination patterns 505 at the two positions.

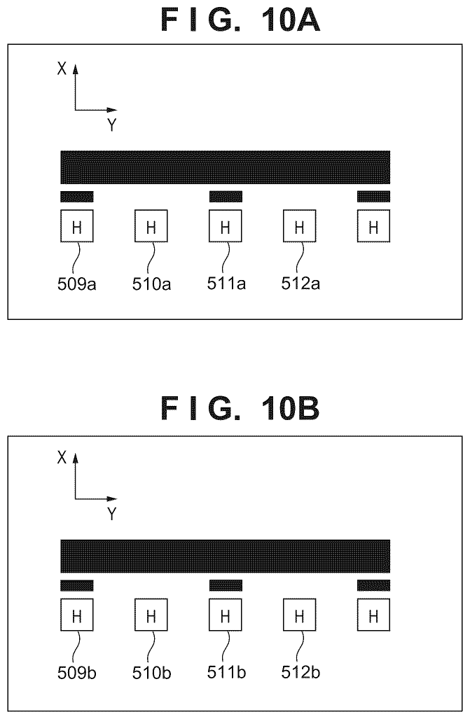

FIG. 10A shows the left determination pattern, of the determination patterns 505 at the two positions, which is printed by using the nozzles of the chip 31. FIG. 10B shows the right determination pattern printed by using the nozzles of the chip 38. For the sake of descriptive convenience, on the left determination pattern, the tile patterns 509 to 512 in FIG. 6B are expressed as tile patterns 509a to 512a, whereas on the right determination pattern, the tile patterns 509 to 512 in FIG. 6B are expressed as tile patterns 509b to 512b.

In this embodiment, the displacement amounts between the printheads 14 are specified as displacement amounts with respect to the reference direction. Accordingly, first of all, a reference direction is set. As an example of the embodiment, a reference direction is determined by averaging the nozzle array directions obtained from the tile patterns 509 and 510 printed by the black (K) printhead 14K and the cyan (C) printhead 14C. Since printed patterns using a black ink and a cyan ink have relatively high densities, higher recognition accuracy can be obtained.

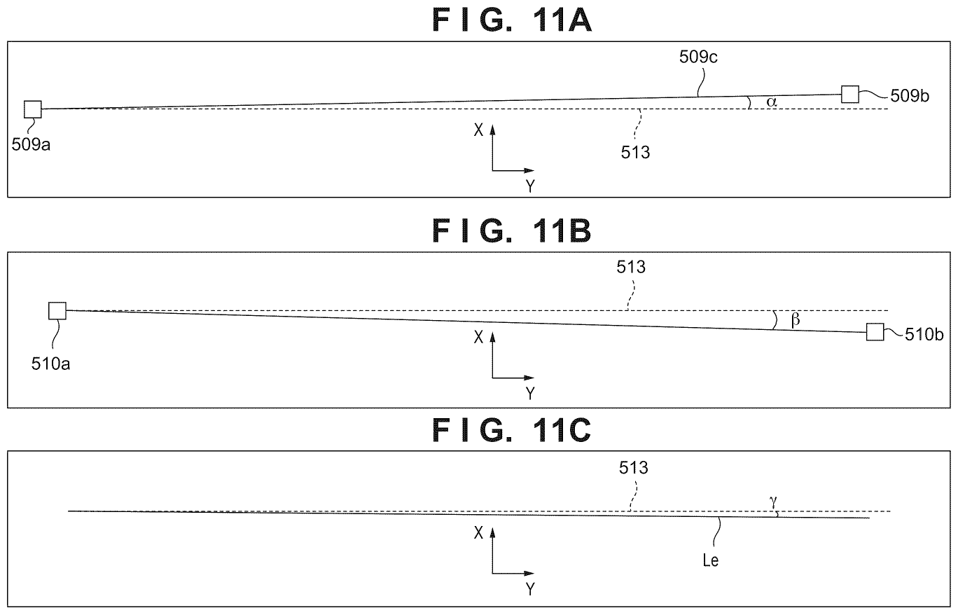

FIGS. 11A and 11B are views for explaining a method of specifying the longitudinal directions of the printheads 14K and 14C. As shown in FIG. 11A, the longitudinal direction of the printhead 14K is specified by a straight line 509c connecting tile patterns 509a and 509b. The straight line 509c is specified as, for example, a straight line passing through the centers of the tile patterns 509a and 509b. An intersecting angle α between a straight line 513 indicating the element array direction of the reading unit 17 and the straight line 509c is calculated. Likewise, as shown in FIG. 11B, the longitudinal direction of the printhead 14C is specified by a straight line 510c connecting tile patterns 510a and 510b. An intersecting angle β between the straight line 513 and the straight line 510c is calculated. The direction intersecting the straight line 513 at an average value γ(=(α+(−β))/2) of the intersecting angles α and β is determined as a reference direction. FIG. 11C exemplarily shows a straight line Le indicating the reference direction. Determining a reference direction from the longitudinal directions of the plurality of printheads 14 can set a more appropriate reference direction even if the reading unit 17 has a mounting error.

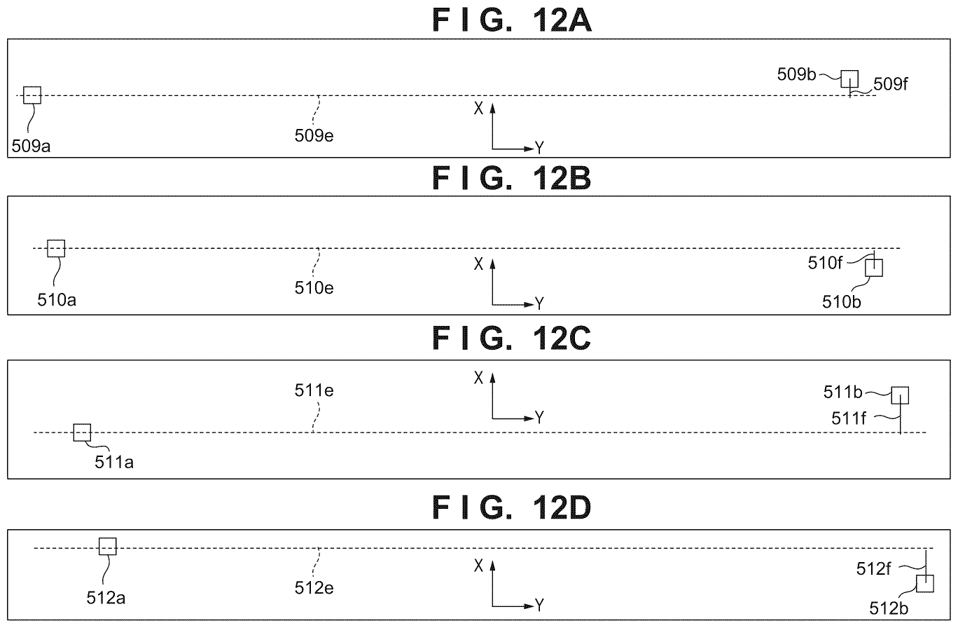

A position displacement in the X direction due to the inclination of each printhead 14 in the longitudinal direction with respect to the reference direction is calculated. FIGS. 12A to 12D are explanatory views. In this embodiment, the distance between a straight line in the reference direction which passes through one of the two tile patterns and the other tile pattern is calculated for each printhead, and the calculated distance is defined as a position displacement amount. Such a position displacement amount will be described more specifically.

FIG. 12A shows an example of calculating the position displacement of the printhead 14K. A straight line 509e is drawn from the tile pattern 509a to the reference direction. The straight line 509e corresponds to the straight line Le (FIG. 11C) passing through the tile pattern 509a. A vertical line 509f is drawn from the tile pattern 509b to the straight line 509e. The length of the vertical line 509f is defined as a position displacement amount due to the inclination of the printhead 14K. The length of the vertical line 509f can be the length from the center of the tile pattern 509b to the straight line 509e.

The same applies to the remaining printheads 14. FIG. 12B shows an example of calculating the position displacement of the printhead 14C. A straight line 510e is drawn from the tile pattern 510a to the reference direction. A vertical line 510f is drawn from the tile pattern 510b to the straight line 510e. The length of the vertical line 510f is defined as a position displacement amount due to the inclination of the printhead 14C. FIG. 12C shows an example of calculating the position displacement of the printhead 14M. A straight line 511e is drawn from a tile pattern 511a to the reference direction. A vertical line 511f is drawn from a tile pattern 511b to the straight line 511e. The length of the vertical line 511f is defined as a position displacement amount due to the inclination of the printhead 14M. FIG. 12D shows an example of calculating the position displacement of the printhead 14Y. A straight line 512e is drawn from a tile pattern 512a to the reference direction. A vertical line 512f is drawn from a tile pattern 512b to the straight line 512e. The length of the vertical line 512f is defined as a position displacement amount due to the inclination of the printhead 14Y.

When a position displacement amount at one end of the printhead 14 in the Y direction is 0, the position displacements specified by the lengths of the vertical lines 509f to 512f each correspond to a position displacement amount at the other end. In this embodiment, a correction amount is set for each chip (on a chip basis). Each printhead 14 has eight chips, namely the chips 31 to 38. The chip 31 has a position displacement of 0, and the chip 38 has a position displacement corresponding to the lengths of the vertical lines 509f to 512f. The position displacement amount of the chip 38 is proportionally distributed to the chips 32 to 37 in accordance with their positions in the Y direction. If, for example, the position displacement amount of the chip 38 is Xd, the position displacement amount is distributed as follow: chip 32: Xd·1/7, chip 33: Xd·2/7, chip 34: Xd·3/7, chip 35: Xd·4/7, chip 36: Xd·5/7, and chip 37: Xd·6/7. Correction is performed by adding these position displacement amounts to the displacements (in the X direction) between the chips described above.

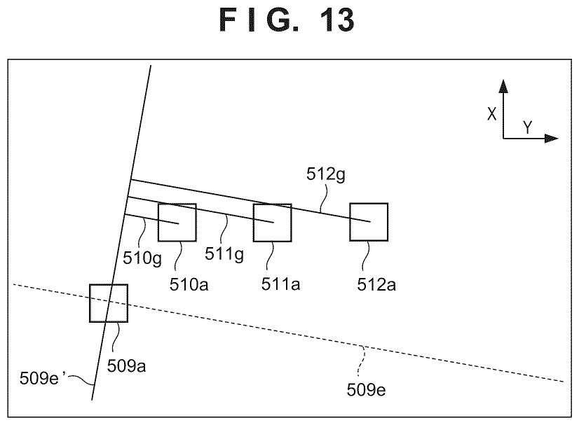

A method of calculating the position displacements between the plurality of printheads 14 in the Y direction due to the inclinations of the printheads 14 will be described next with reference to FIG. 13. An example of obtaining such position displacements based on the relative positional relationships between the tile patterns 509a to 512a shown in FIG. 10A will be described below.

First of all, the printhead 14 as a reference is selected. Although the following will exemplify a case where the printhead 14K is set as a reference, any one of the remaining printheads 14C to 14Y may be set as a reference. As shown in FIG. 13, the straight line 509e (the same as in FIG. 12A) is drawn passing through the tile pattern 509a to the reference direction. These operations correspond to the printhead 14K. A straight line 509e′ is drawn so as to be perpendicular to the straight line 509e. The straight line 509e′ may be a straight line passing through the center of the tile pattern 509a.

A vertical line 510g is drawn from the tile pattern 510a to the straight line 509e′. The difference between the ideal distance in the Y direction between the printhead 14K and the printhead 14C and the length of the vertical line 510g is defined as a position displacement amount in the Y direction due to the inclination of the printhead 14C.

Likewise, a vertical line 511g is drawn from the tile pattern 511a to the straight line 509e′. The difference between the ideal distance in the Y direction between the printhead 14K and the printhead 14M and the length of the vertical line 511g is defined as a position displacement amount in the Y direction due to the inclination of the printhead 14M. A vertical line 512g is drawn from the tile pattern 512a to the straight line 509e′. The difference between the ideal distance in the Y direction between the printhead 14K and the printhead 14Y and the length of the vertical line 512g is defined as a position displacement amount in the Y direction due to the inclination of the printhead 14Y.

A correction amount is set for each head (on a head basis). Correction is performed by adding each position displacement amount to the displacement (in the Y direction) between the chips described above. That is, the position displacement amount calculated concerning the printhead 14C is added to the displacements (in the Y direction) between the respective chips of the printhead 14C. Likewise, the position displacement amount calculated concerning the printhead 14M is added to the displacements (in the Y direction) between the respective chips of the printhead 14M. The position displacement amount calculated concerning the printhead 14Y is added to the displacements (in the Y direction) between the respective chips of the printhead 14Y.

Although the case shown in FIG. 13 uses the tile patterns 509a to 512a shown in FIG. 10A, the tile patterns 509b to 512b shown in FIG. 10B may be used. In addition, position displacement amounts may be obtained from the respective tile patterns in FIGS. 10A and 10B, and the average values of the respective position displacement amounts may be set as final position displacement amounts.

### Correction Example

A method of correcting the displacements of the printing positions (landing positions) of ink discharged from the nozzles of each printhead 14 based on calculated displacement amounts will be described. The displacements (in the X direction) between the nozzle arrays are corrected by changing the discharge timings of ink from the respective nozzles based on a displacement amount set with reference to nozzle array H. This will correct the displacements of the landing positions of ink from the respective nozzle arrays relative to nozzle array H.

The inclination of each chip is corrected by, for example, shifting print data (dot data) in the conveying direction in accordance with the inclination.

The displacements (in the X direction) between the chips are corrected by changing the discharge timings of the chips 32 to 38 with respect to the chip 31. More specifically, the discharge timings of all the nozzle arrays of the chip 32 are uniformly corrected with respect to the chip 31 by amounts corresponding to the displacement amounts between the chips. Correction for the displacement amount of the chip 32 is applied to the chip 33 to perform correction corresponding to the addition of the correction amount for the chip 32 with respect to the chip 31. Similar correction is applied to the chips 33 to 38. As described above, the correction amounts for the displacements (in the X direction) between the chips include the position displacement amounts between the printheads 14 in the X direction.

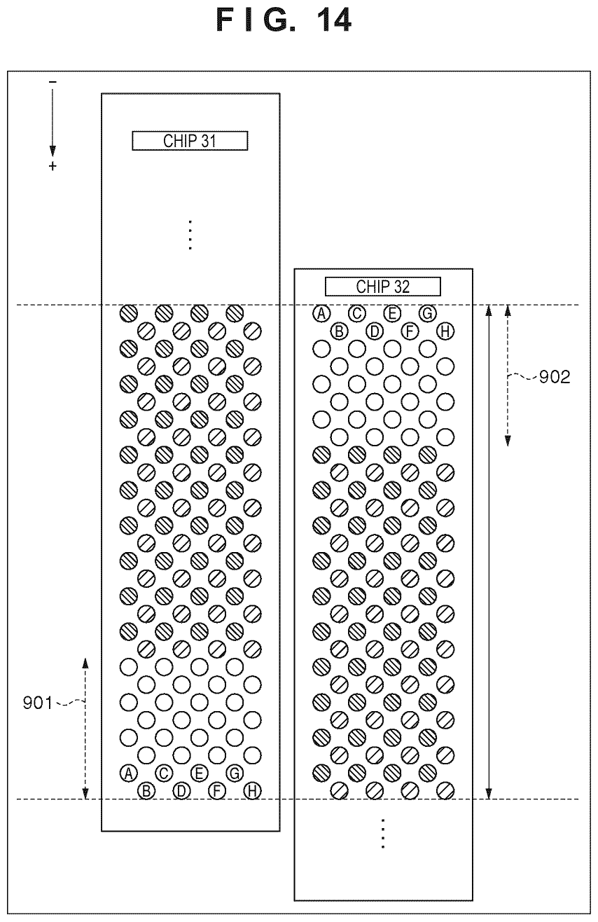

The displacements (in the Y direction) between chips are corrected by shifting the nozzle regions in use. FIG. 14 is an enlarged view of the overlapping portion between the chips. In each of the eight nozzle arrays, for example, nozzles are arranged with a resolution of 1,200 dpi. In addition, nozzle arrays A, C, E, and G are arranged so as to be shifted from nozzle arrays B, D, F, and H by 2,400 dpi. Regions 901 and 902 are arrangement regions of adjustment nozzles (spare nozzles) for nozzle shift.

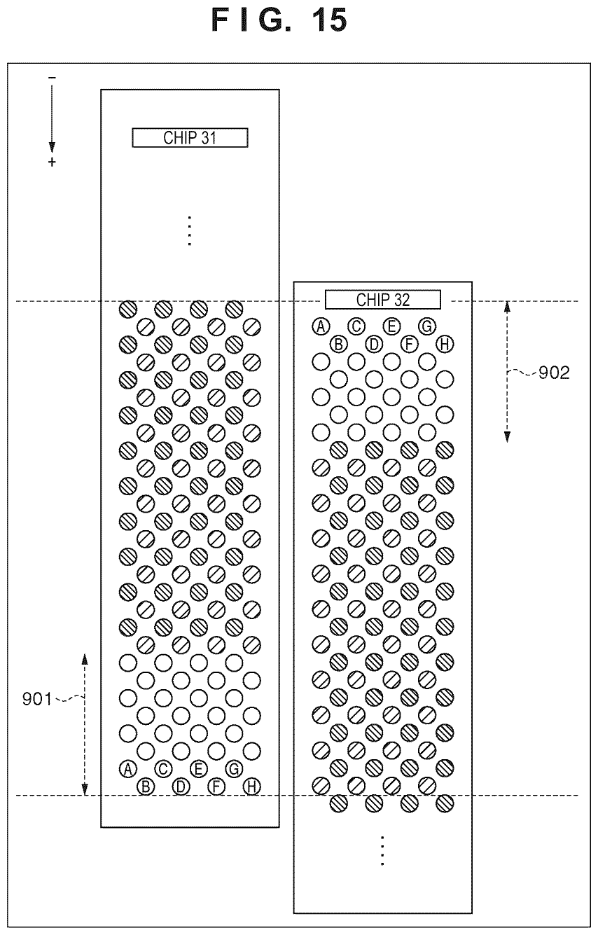

If the position of the chip 32 is shifted from the chip 31 to the + side by 2,400 dpi, the relationship between the orifices and print data is changed as shown in FIG. 15. More specifically, the print data of all the arrays of the chip 32 is shifted to the-side by one nozzle (1,200 dpi). In addition, the print data of each pair of nozzle arrays, namely nozzle arrays A and B, nozzle arrays C and D, nozzle arrays E and F, and nozzle arrays G and H, are interchanged. This makes it possible to perform correction at intervals of 2,400 dpi.

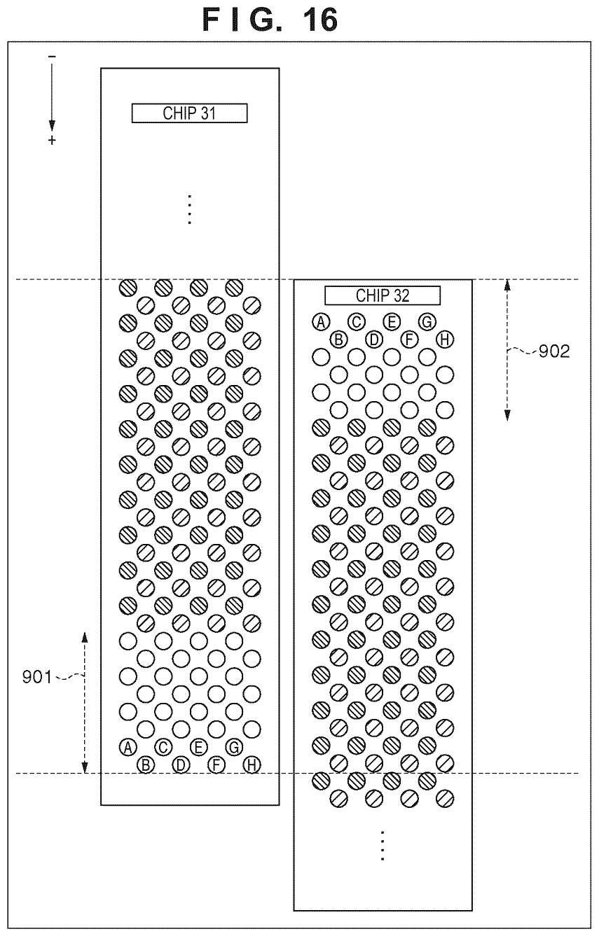

If the position of the chip 32 is shifted to the + side by 1,200 dpi with respect to the chip 31, the relationship between the orifices and print data is changed as shown in FIG. 16. More specifically, the print data of all the nozzle arrays of the chip 32 is shifted to the-side by an amount corresponding to one nozzle (1,200 dpi). This makes it possible to perform correction at intervals of 1,200 dpi.

In correcting the displacements (in the Y direction) between chips, as in correcting the displacements (in the X direction) between chips, all the chips are matched with the chip 31. That is, the displacement amounts between the respective adjacent chips are calculated, and the nozzles in use of the chip 32 are shifted with respect to the chip 31. The chip 33 is corrected by an amount corresponding to the sum of the correction amount for the displacement amount with respect to the chip 32 and the correction amount for the chip 32 with respect to the chip 31. The chips 33 to 38 are corrected in the same manner. As described above, the correction amounts with respect to the displacements (in the Y direction) between the chips include the position displacement amounts in the Y direction between the printheads 14.

As described above, according to this embodiment, a read result on a test pattern is analyzed, and the displacements occurring between the constituent elements of each printhead 14 and between the plurality of printheads 14 can be corrected based on the relative positional relationship between the plurality of read tile patterns. In correcting the inclinations between the printheads 14, the average of the inclinations of the printhead 14K and the printhead 14C is used to determine a reference direction. Not setting the specific printhead 14 as a reference can eliminate the necessity to perform precise positioning with respect to either printhead 14.

It is a known fact that it is generally important in terms of print quality to perform physical positioning of printheads. There is also provided a printing apparatus that allows the replacement of the worn printhead 14. Under the circumstances, there is also provided a printing apparatus having a mechanism for correcting the mounting position of a printhead. Even with the correcting mechanism, a printhead sometimes inclines. In addition, if the accuracy of the correcting mechanism remains the same, inclinations often occur with predetermined variations. Accordingly, using the average of the inclinations of the plurality of printheads 14 as in this embodiment can correct the displacements of printing positions due to the inclinations more accurately.

If a specific printhead is set as a reference, a large physical inclination of the reference printhead may cause a local deterioration in image quality as a result of correction. Using the average of the inclinations of the plurality of printheads 14 as in this embodiment can suppress the occurrence of a local deterioration in image quality.

### Second Embodiment

As shown in FIGS. 11A to 11C, the first embodiment uses the average value of the intersecting angles between the longitudinal directions of the printheads 14K and 14C and the element array direction of the reading unit 17 to determine a reference direction. However, the nozzle array direction used for the determination of a reference direction is not limited to a combination of the printheads 14K and 14C. For example, the nozzle array direction may be a combination of the two printheads 14 on the most upstream side and the most downstream side in the X direction (the printheads 14K and 14Y in the case shown in FIG. 9A). Alternatively, the nozzle array direction may be a combination of the printheads 14 located in the middle in the X direction (the printheads 14C and 14M in the case of FIG. 9A).

The number of printheads 14 used for the determination of a reference direction is not limited to two and may be three or more. Using three or more printheads 14 will complicate the algorithm for the calculation of a reference more than using the two printheads 14 but can improve the reliability of a reference direction.

In determining a reference direction, after the longitudinal directions of the plurality of printheads 14 are specified, the average value of the intersecting angles between the element array direction of the reading unit 17 and the respective longitudinal directions excluding the largest and smallest intersecting angles may be obtained. More specifically, for example, the four longitudinal directions of the printheads 14K to 14Y are specified by the method exemplarily shown in FIGS. 11A and 11B, and the intersecting angles with the element array direction are specified. If the intersecting angles (absolute values) between the longitudinal directions of the printheads 14K and 14Y and the element array direction are respectively the maximum and minimum values, a reference direction is determined from the average value of the intersecting angles between the longitudinal directions of the printheads 14C and 14M and the element array direction.

### Third Embodiment

The first embodiment has exemplified the printing apparatus 20 including the four printheads 14 corresponding to the four types of inks. However, the present disclosure can also be applied to a printing apparatus including five or more printheads 14 corresponding to five or more types of inks. Depending on the types of ink to be used, a transparent liquid, white ink, or light ink is sometimes used. The transparent liquid is, for example, a reaction liquid that improves the fixability of other types of inks.

In determining the reference direction shown in FIGS. 11A to 11C, the longitudinal direction of the printhead for the transparent liquid may be excluded. That is, a reference direction is determined based on the longitudinal directions of printheads other than the printhead for the transparent liquid. In addition, the displacement of the printing position of the printhead for the transparent liquid may not be corrected. This is because the transparent liquid is not visualized on a sheet S.

Similarly, if the sheet S is white or the background color of an image is white, the longitudinal direction of the printhead for the white ink may be excluded in determining the reference direction shown in FIGS. 11A to 11C. In addition, the displacement of the printing position may not be corrected.

Similarly, in determining the reference direction shown in FIGS. 11A to 11C, the longitudinal direction of the printhead for the light ink may be excluded. In addition, the printing position displacement may not be corrected. This is because the displacement of the printing position of light ink on an image is considered not to be noticeable.

### Fourth Embodiment

The first embodiment has exemplified the case where one of the determination patterns 505 at the two positions is printed by using the nozzles of the chip 31 of each printhead 14, and the other is printed by using the nozzles of the chip 38 of each printhead 14. These chips 31 and 38 are farthest from each other in the Y direction, and hence the advantage of using them is facilitation in analyzing the intersecting angles described with reference to FIGS. 11A and 11B. On the other hand, the determination patterns 505 may be printed by using any of the remaining chips 32 to 36.

In addition, a test pattern may include determination patterns 505 at three or more positions. In this case, the straight line 509c exemplarily shown in FIG. 11A may be an approximate straight line with respect to tile patterns 509 at three or more positions.

### Fifth Embodiment

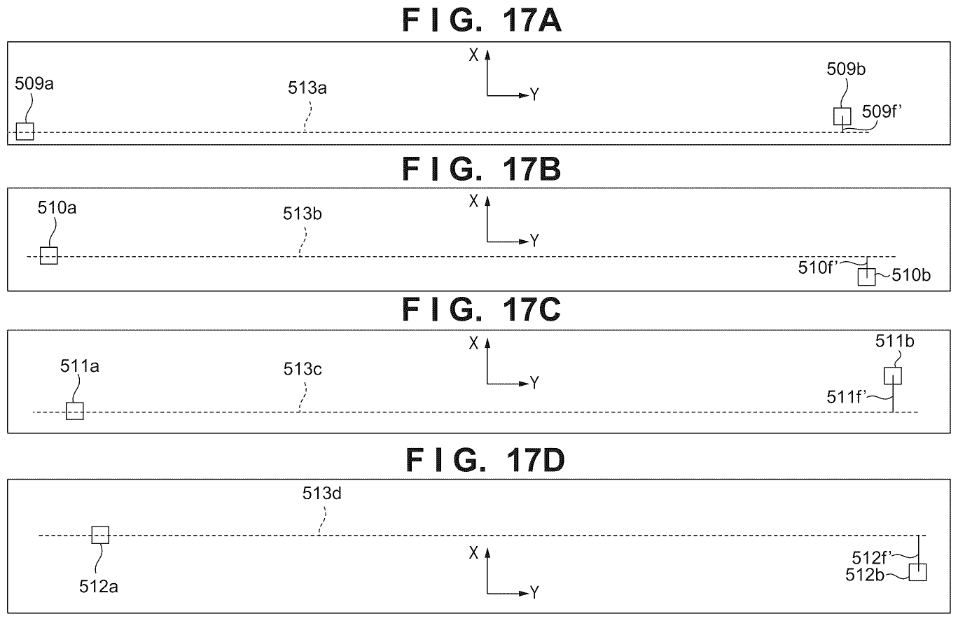

The element array direction of a reading unit 17 may be set as a reference direction. Although this reference direction is influenced by the mounting accuracy of the reading unit 17, the position displacement due to the inclination of a printhead 14 can be relatively easily corrected. FIGS. 17A to 17D are views for explaining this embodiment and show an example of calculating a position displacement in the X direction due to the inclination of each printhead 14 in the longitudinal direction. Straight lines 513a to 513d each indicate the element array direction of the reading unit 17 and are identical to the straight line 513 shown in FIGS. 11A and 11B. In this embodiment, the straight line 513 is a straight line indicating a reference direction.

FIG. 17A shows an example of calculating the position displacement of a printhead 14K. The straight line 513a is drawn from a tile pattern 509a to the reference direction. A vertical line 509f is drawn from a tile pattern 509b to the straight line 513a. The length of the vertical line 509f′is defined as a position displacement amount due to the inclination of the printhead 14K. The length of the straight line 509f′ can be defined as the length from the center of the tile pattern 509b to the straight line 513a.

The same applies to the remaining printheads 14. FIG. 17B shows an example of calculating the position displacement of the printhead 14C. The straight line 513b is drawn from a tile pattern 510a to the reference direction. A vertical line 510f is drawn from the tile pattern 510b to the straight line 513b. The length of the vertical line 510f is defined as a position displacement amount due to the inclination of the printhead 14C. FIG. 17C shows an example of calculating the position displacement of the printhead 14M. The straight line 513c is drawn from a tile pattern 511a to the reference direction. A vertical line 511f is drawn from a tile pattern 511b to the straight line 513c. The length of the vertical line 511f is defined as a position displacement amount due to the inclination of the printhead 14M. FIG. 17D shows an example of calculating the position displacement of the printhead 14Y. The straight line 513d is drawn from a tile pattern 512a to the reference direction. A vertical line 512f′ is drawn from a tile pattern 512b to the straight line 513d. The length of the vertical line 512f′ is defined as a position displacement amount due to the inclination of the printhead 14Y.

When a position displacement amount at one end of the printhead 14 in the Y direction is 0, the position displacements specified by the lengths of the vertical lines 509f′ to 512f′ each correspond to a position displacement amount at the other end. As in the first embodiment, a correction amount is set on a chip basis. A chip 31 has a position displacement of 0, and a chip 38 has a position displacement corresponding to the lengths of the vertical lines 509f′ to 512f′. The position displacement amount of the chip 38 is proportionally distributed to chips 32 to 37 in accordance with their positions in the Y direction.

A method of calculating the position displacements in the Y direction between the plurality of printheads 14 due to the inclinations of the printheads 14 is the same as that in the first embodiment exemplarily shown in FIG. 13. In brief, the straight line 513a passing through the tile pattern 509a is drawn instead of the straight line 509e oriented in the reference direction, and a straight line (a straight line 513a′) perpendicular to the straight line 513a is drawn. Vertical lines are respectively drawn from the tile patterns 510a to 512a to the straight line 513a′, and the differences between the lengths of the vertical lines and the ideal distances in the Y direction between the printhead 14K and the remaining printheads 14C to 14Y are defined as position displacement amounts in the Y direction. Correction amounts are set in the same manner as in the first embodiment and performed on a head basis. Correction is performed by adding each position displacement amount to the displacement (in the Y direction) between the chips described above.

Setting the element array direction of the reading unit 17 as a reference direction in this manner makes it possible to obtain a desired result by precisely adjusting the physical inclination of the reading unit 17 at the time of manufacturing the printing apparatus 20. In addition, in general, as compared with the printheads 14, the replacement frequency of the reading unit 17 is considerably low. In replacing a printhead, when the element array direction is set as a reference direction, the re-mounting of a printhead itself does not require precise inclination adjustment. This can reduce the trouble of adjustment at the time of the replacement of a printhead by the user or serviceman.

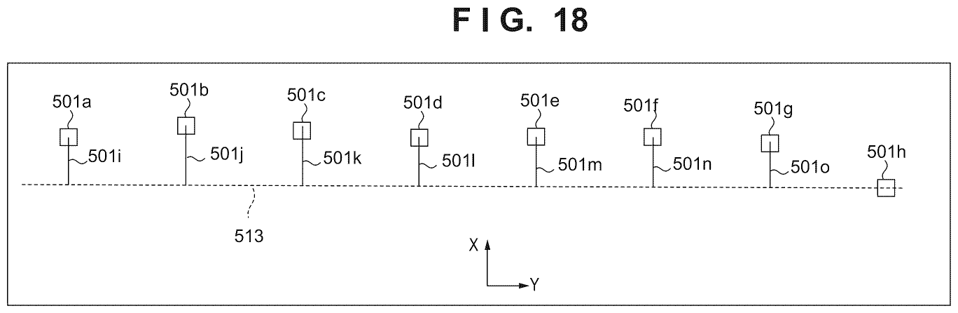

According to the idea of this embodiment, the displacements (in the X direction) between chips can also be analyzed with reference to the element array direction. FIG. 18 shows an example of this operation.

Referring to FIG. 18, tile patterns 501a to 501g correspond to one of the tile patterns 508 of the determination patterns 61 to 68 in FIG. 5. More specifically, the tile pattern 501a is included in the determination pattern 61. The tile pattern 501b is included in the determination pattern 62. The same applies to tile patterns 501c to 501g. In addition, the tile patterns 501a to 501g each correspond to tile pattern “H” at the right end of the tile pattern 508 shown in FIG. 6A.

In the case shown in FIG. 18, the chip 38 is set as a reference, and a straight line 513 is drawn passing through the tile pattern 501h corresponding to the chip 38. The straight line 513 is a straight line oriented in the element array direction of the reading unit 17. The straight line 513 may be a straight line passing through the center of the tile pattern 501h.

Vertical lines 501i to 501o are drawn from the tile patterns 501a to 501g to the straight line 513. The lengths of the vertical lines 501i to 501o are defined as the displacement amounts (in the X direction) of the corresponding chips. For example, the length of the vertical line 501i is defined as the inter-chip displacement amount (in the X direction) of the chip 31.

Correcting the inter-chip displacement (in the X direction) leads to correcting the inclination of one printhead 14. This can further simplify the correction algorithm. This technique can be applied to a printing apparatus required to implement high-speed printing.

### Sixth Embodiment

The user may be allowed to select a method of determining a reference direction from a method of determining a reference direction from the longitudinal directions of a plurality of printheads 14 as in the first embodiment (to be referred to as a head reference method) and a method of determining the element array direction of a reading unit 17 as a reference direction as in the fifth embodiment (to be referred to as an element array reference method). In either of the head reference method and the element array reference method, a printed image after correction sometimes inclines. Allowing the user to select a method of determining a reference direction makes it possible to provide an image in accordance with the preference of the user.

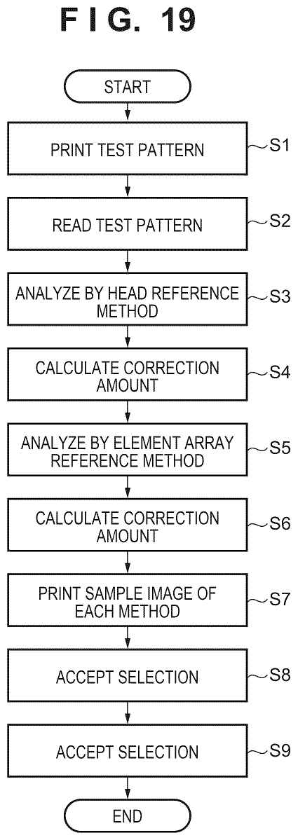

FIG. 19 is a flowchart showing a processing example in this embodiment. A control unit 13 or an external device 16 (a host computer or the like) executes this flowchart. The flowchart is executed when, for example, a printhead 14 is replaced or an execution instruction is issued by the user.

In step S1, printheads 14K to 14Y print the test pattern in FIG. 5 on a sheet S. In step S2, the reading unit 17 reads the printed test pattern. In step S3, the read result obtained in step S2 is analyzed by the head reference method. In step S4, a correction amount for a printing position displacement is calculated based on the analysis result obtained in step S3. In step S5, the read result obtained in step S2 is analyzed by the element array reference method. In step S6, a correction amount for the printing position displacement is calculated based on the analysis result obtained in step S5.

In step S7, the printheads 14K to 14Y print two types of sample images on the sheet S. The two types of sample images are identical images differing in a correction amount for a printing position displacement. One of the images is a printed image using the correction amount calculated in step S4, and the other is a printed image using the correction amount calculated in step S6.

In step S8, the selection by the user is accepted. This selection is to select one of the two types of images printed in step S7 and is user selection to select a method of determining a reference direction from the head reference method and the element array reference method. In step S9, either of the correction amounts calculated in steps S4 and S6 is set as a correction amount to be used for subsequent printing in accordance with the selection in step S8.

According to the processing example shown in FIG. 19, since the user of the printing apparatus 20 can select either of two types of images corresponding to different methods of determining a reference direction by visually comparing the images with each other, the preference of the user can be reflected in correction. Note that in the processing example shown in FIG. 19, two types of images are presented to the user to allow he/she to select the head reference method or the element array reference method as a method of determining a reference direction. However, the presentation of two types of images may be omitted to make the user simply select either of the above methods.

### Seventh Embodiment

The above embodiments have exemplified the continuous sheet S in a roll shape as a print medium. However, a cut sheet may be used as a print medium. In addition, the continuous sheet S in a roll shape may be taken up in the roll shape without being cut.

The above embodiments use the scheme of moving the sheet S to the plurality of printheads 14 by using the conveying mechanism while the positions of the plurality of printheads 14 are fixed. However, the embodiments may use a scheme of printing an image on the sheet S while moving the printheads 14 with respect to the sheet S. That is, the embodiments may include a plurality of printheads and a mechanism of relatively moving a print medium in the X direction.

### Other Embodiments

Embodiments of the present disclosure can be implemented by the processing of supplying a program for implementing one or more functions of the above embodiments to a system or apparatus via a network or storage medium and causing one or more processors in the system or apparatus to read out and execute the program. Embodiments of the present disclosure can also be implemented by a circuit configured to implement one or more functions (for example, ASIC).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-212321, filed Dec. 15, 2023, which is hereby incorporated by reference herein in its entirety.

What is claimed is:

1. A printing apparatus comprising:
a plurality of printheads arranged in a first direction;
a moving unit configured to relatively move the plurality of printheads and a print medium in the first direction;
a reading unit configured to read a test pattern on a print medium printed by the plurality of printheads;
an analyzing unit configured to analyze the test pattern read by the reading unit; and
a correcting unit configured to correct displacements of printing positions of the plurality of printheads based on an analysis result obtained by the analyzing unit,
wherein each printhead includes a plurality of chips arranged in a longitudinal direction of the printhead which intersects the first direction, each chip including a plurality of nozzles arranged in the longitudinal direction,
the test pattern includes a plurality of determination patterns arranged in a second direction intersecting the first direction,
each determination pattern includes a pattern printed by each printhead,
the analyzing unit analyzes a position displacement between a reference direction and the longitudinal direction of each printhead specified from the plurality of determination patterns,
the reference direction is determined from longitudinal directions of at least two printheads specified from the plurality of determination patterns, and
the correcting unit corrects a displacement of a printing position based on the position displacement analyzed by the analyzing unit.

2. The printing apparatus according to claim 1, wherein the plurality of printheads include a first printhead configured to discharge a black ink and a second printhead configured to discharge a cyan ink, and
the reference direction is determined from a longitudinal direction of the first printhead and a longitudinal direction of the second printhead specified from the plurality of determination patterns.

3. The printing apparatus according to claim 1, wherein the reading unit includes a plurality of reading elements arranged in an element array direction intersecting the first direction, and
at least two longitudinal directions used to determine the reference direction are longitudinal directions excluding longitudinal directions, of the longitudinal directions of the plurality of printheads specified from the plurality of determination patterns, which respectively exhibit a largest displacement and a smallest displacement with respect to the element array direction.

4. The printing apparatus according to claim 1, wherein the plurality of printheads include a first printhead configured to discharge a transparent liquid, and
the reference direction is determined from longitudinal directions of the printheads, except for the first printhead, specified from the plurality of determination patterns.

5. The printing apparatus according to claim 1, wherein the plurality of determination patterns are two determination patterns printed by nozzles of each of chips located at two end portions of each printhead in the longitudinal direction.

6. The printing apparatus according to claim 5, wherein the analyzing unit calculates, for each of the printheads, a distance between a straight line which passes through one of the two determination patterns corresponding to the printhead and is oriented in the reference direction and the other of the two patterns.

7. The printing apparatus according to claim 1, wherein each pattern of the determination patterns is a tile pattern, and
each determination pattern includes the tile pattern corresponding to each printhead printed in the second direction.

8. The printing apparatus according to claim 1, wherein the plurality of chips are arranged in a staggered pattern.

9. The printing apparatus according to claim 1, wherein the correcting unit sets a correction amount for a position displacement due to an inclination of each printhead in the longitudinal direction for each of the chips.

10. The printing apparatus according to claim 1, wherein each printhead is a full-line head.

11. A control method for a printing apparatus including a plurality of printheads arranged in a first direction, a moving unit configured to relatively move the plurality of printheads and a print medium in the first direction, and a reading unit configured to read a test pattern on a print medium printed by the plurality of printheads, each printhead including a plurality of chips arranged in a longitudinal direction of the printhead which intersects the first direction and each chip including a plurality of nozzles arranged in the longitudinal direction, the control method comprising:
analyzing a test pattern read by the reading unit; and
correcting displacements of printing positions of the plurality of printheads based on an analysis result obtained in the analyzing,
wherein the test pattern includes a plurality of determination patterns arranged in a second direction intersecting the first direction,
each determination pattern includes a pattern printed by each printhead,
in the analyzing, a position displacement between a reference direction and the longitudinal direction of each printhead specified from the plurality of determination patterns is analyzed,
the reference direction is determined from longitudinal directions of at least two printheads specified from the plurality of determination patterns, and
in the correcting, a displacement of a printing position is corrected based on the position displacement analyzed in the analyzing.
